(19) United States
(12) Patent Application Publication
(10) Pub. No.: US 2014/0368400 A1
(43) Pub. Date: Dec. 18, 2014

(54) DUAL BAND WIFI ANTENNA FOR MIMO WIRELESS COMMUNICATION

(71) Applicant: PC-TEL, Inc., Bloomingdale, IL (US)

(72) Inventors: Jesse Lin, Lisle, IL (US); Zankar Vakil, Roselle, IL (US)

(21) Appl. No.: 14/302,704

(22) Filed: Jun. 12, 2014

Related U.S. Application Data
(60) Provisional application No. 61/834,528, filed on Jun. 13, 2013.

(51) Int. Cl. H01Q 1/52; H01Q 7/00; H01Q 25/00

(52) U.S. Cl. CPC H01Q 1/523; H01Q 25/00; H01Q 7/00
USPC 343/843; 343/893; 343/866

(57) ABSTRACT

A dual band WiFi antenna is provided. The antenna can include a printed circuit board, a first antenna element etched onto the printed circuit board, a second antenna element etched onto the printed circuit board, a first RF choke etched onto the printed circuit board near a first end of the printed circuit board, and a second RF choke etched onto the printed circuit board near the first end of the printed circuit board. The first antenna element and the first RF choke can work within a first frequency band, and the second antenna element and the second RF choke can work with a second frequency band.

### CROSS-REFERENCE TO RELATED APPLICATIONS

This application claims priority to U.S. Provisional Patent Application No. 61/834,528 filed Jun. 13, 2013 and titled “Dual Band WiFi Antenna for MIMO Wireless Communication”. U.S. Application No. 61/834,528 is hereby incorporated by reference.

### FIELD

The present invention relates generally to antennas. More particularly, the present invention relates to a dual band WiFi antenna that can be used in connection with multiple input and multiple output (MIMO) systems.

### BACKGROUND

In known MIMO systems, there is a desire to exploit the multi-path capabilities of the system to enhance the system capacity. One way to exploit the multi-path capabilities of a MIMO system is to incorporate multiple antennas and/or multi-band antennas at both the transmitter and receiver. That is, a transmitter sends multiple beams from multiple transmit antennas, and the beams are received by multiple receive antennas at a receiver.

It is desirable for the beams sent from the transmit antennas in a MIMO system to be wide. Accordingly, it has been necessary for known MIMO systems to include antennas spaced at a predetermined distance apart from one another. Such separation between the antennas prevents interference between the beams and prevents band-to-band coupling between beams from antennas operating at different frequencies.

However, due to space and size constraints, it may be desirable to place antennas of a MIMO system in close proximity to one another. For example, a base for the antennas may be of a limited size. In such a situation, it would be desirable to maintain the wide beam of the antennas while still preventing interference and band-to-band coupling between the antenna beams.

However, known antennas placed within close proximity to one another in a MIMO system present several disadvantages. First, mutual surface radiation from the antennas can couple with each other. Additionally, when the antennas are elevated above a large ground reflector, a small antenna base can defocus the reflection of the main radiation beam. Finally, low isolation between the antennas can introduce signal interference.

Antennas that can be used in connection with MIMO systems and that can address some of the above-identified issues are known in the art. For example, the antenna disclosed in U.S. Pat. No. 8,253,647 discloses one such known antenna. U.S. Pat. No. 8,253,647 is assigned to the assignee hereof and is hereby incorporated by reference.

However, many known antennas are monopole antennas and accordingly, only perform in a single band, for example, a 2.4 GHz band or a 5.8 GHz band, and only perform on a single access point platform. Notwithstanding these limitations, continuous cost and competition pressure within the wireless industry has driven antenna designs to have dual functionality and capability and to fit into different and more complex WiFi access point metal platforms for MIMO systems. For example, some known antennas that can be used in connection with MIMO systems include dual band antennas that can perform on different access point platforms. However, when such dual functioning antennas are integrated into a small MIMO package or footprint, the distance between antenna elements is so small that inter-coupling is a serious issue.

Known antennas attempt to solve the inter-coupling issue by adding an additional RF choke at the element side. However, the addition of such an RF choke has mandated the antenna having a longer physical length. In some cases, the physical length of such antennas is too long for many applications. Additionally, the addition of such an RF choke mandates a larger space for the broader bandwidth element so that the element can fit into different WiFi metal platforms.

In view of the above, there is a need for an improved dual band antenna.

### BRIEF DESCRIPTION OF THE DRAWINGS

FIG. 1A is a side view of a dual band antenna in accordance with disclosed embodiments;

FIG. 1B is a top view of a dual band antenna in accordance with disclosed embodiments;

FIG. 2 is a front schematic view of a printed circuit board for a dual band antenna in accordance with disclosed embodiments;

FIG. 3 is a back schematic view of a printed circuit board for a dual band antenna in accordance with disclosed embodiments;

FIG. 4A is a perspective view of a connector body for a dual band antenna in accordance with disclosed embodiments;

FIG. 4B is a side view of a connector body for a dual band antenna in accordance with disclosed embodiments;

FIG. 5A is a perspective view of a WiFi access point metal platform in accordance with disclosed embodiments;

FIG. 5B is a perspective view of a WiFi access point metal platform in accordance with disclosed embodiments;

FIG. 5C is a perspective view of a WiFi access point metal platform in accordance with disclosed embodiments;

FIG. 6 is a graph of exemplary test data showing a standing wave ratio of an antenna in accordance with disclosed embodiments;

FIG. 7 is a graph of exemplary test data showing isolation vs. frequency of an antenna in accordance with disclosed embodiments;

FIG. 8A is a three-dimensional graph of an exemplary radiation pattern generated by an antenna mounted on a WiFi access point metal platform for a 2.4 GHz frequency band in the EL plane in accordance with disclosed embodiments;

FIG. 8B is a three-dimensional graph of an exemplary radiation pattern generated by an antenna mounted on a WiFi access point metal platform for a 2.4 GHz frequency band in the AZ plane in accordance with disclosed embodiments;

FIG. 9A is a three-dimensional graph of an exemplary radiation pattern generated by an antenna mounted on a WiFi access point metal platform for a 5.8 GHz frequency band in the EL plane in accordance with disclosed embodiments; and

FIG. 9B is a three-dimensional graph of an exemplary radiation pattern generated by an antenna mounted on a WiFi access point metal platform for a 5.8 GHz frequency band in the AZ plane in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a dual band WiFi antenna that can use MIMO wireless communication and/or that can be used in connection with MIMO systems. Furthermore, the antenna disclosed herein can address and overcome some of the above-identified deficiencies of known antennas.

In some embodiments, the antenna disclosed herein can include a dual resonance antenna and can operate in at least two frequency bands. For example, in some embodiments, the antenna disclosed herein can operate at or in a relatively lower frequency band, for example, a 2.4 GHz frequency band, and at or in a relatively higher frequency band, for example, a 5.8 GHz frequency band.

In some embodiments, the antenna disclosed herein can be used in connection with a plurality of different WiFi access point metal platforms such that each of the plurality of different WiFi access point metal platforms has a different footprint, a different shape, a different dimension, a different size, and the like. In some embodiments, the antenna disclosed herein can be used in connection with at least two or at least three different WiFi access point metal platforms. Furthermore, in some embodiments, the antenna disclosed herein can be short enough in length to meet customer design requirements while still having RF matching frequency bandwidths that are wide enough to meet customer design requirements.

In some embodiments, the antenna disclosed herein can be a dual band antenna and can include at least three RF chokes. For example, two RF chokes can be located at or near a bottom end of a PCB element. Accordingly, in some embodiments, the antenna disclosed herein can include two RF choke sections without occupying additional physical length at the side of the PCB element. A first RF choke at or near the bottom end of the PCB element can be associated with the relatively lower frequency band of the antenna, for example, the 2.4 GHz frequency band of the antenna, and a second RF choke at or near the bottom end of the PCB element can be associated with the relatively higher frequency band of the antenna, for example, the 5.8 GHz frequency band of the antenna. A third RF choke can be embedded at or in a connector body and can be located below the antenna elements.

In some embodiments, each of the RF chokes in the antenna disclosed herein can include a high impedance section to prevent unwanted common-mode current that interferes with RF matching. In some embodiments, the high impedance section of each of the RF chokes in the antenna can also prevent pattern distortion from metal ground reflection to the antenna.

In some embodiments, the antenna disclosed herein can include a PCB antenna element for the relatively higher frequency band of the antenna, for example, the 5.8 GHz frequency band of the antenna. In some embodiments, the antenna element for the relatively higher frequency band of the antenna can include a radiator, for example, a loop-shaped radiator. In some embodiments, the length of the loop-shaped radiator can be slightly shorter than ¼ wavelength, and in some embodiments, the loop-shaped radiator can have a symmetrical shape, which can provide a balanced radiation pattern.

In some embodiments, the antenna disclosed herein can include an PCB antenna element for the relatively lower frequency band of the antenna, for example, the 2.4 GHz frequency band of the antenna. In some embodiments, the antenna element for the relatively lower frequency band of the antenna can include a folded radiator that is integrated into and/or with the loop-shaped radiator corresponding to the relatively higher frequency band of the antenna. For example, the folded radiator can be bent into two equal parts so as to create a lower profile. In some embodiments, the length of the folded radiator can be substantially equal to ¼ wavelength, and in some embodiments, the line width of the folded radiator can be thin enough so as to carry high impedance characteristics and act as an open circuit to the loop-shaped radiator corresponding to the relatively higher frequency band of the antenna. Accordingly, in some embodiments, the folded radiator can work for the relatively lower frequency band of the antenna while not affecting the relatively higher frequency band of the antenna.

In some embodiments, the antenna disclosed herein can operate in accordance with the principles of the following transmission line equation:

Zᵢₙ=Z_{c}((Z_{L}+jZ_{C}(tan β^{ι}))/(Z_{C}+jZ_{L}(tan β^{ι}))) (1)

where Zᵢₙ is the input impedance, Z_{C} is the characteristic impedance, Z_{L} is the load impedance, and β^{ι} is the length of the transmission line.

For example, when the load impedance is open, that is, Z_{L}=∞, and the length of the transmission line β^{ι} is ¼ wavelength, the input impedance Zᵢₙ will become zero. Accordingly, the whole section can act as an open circuit.

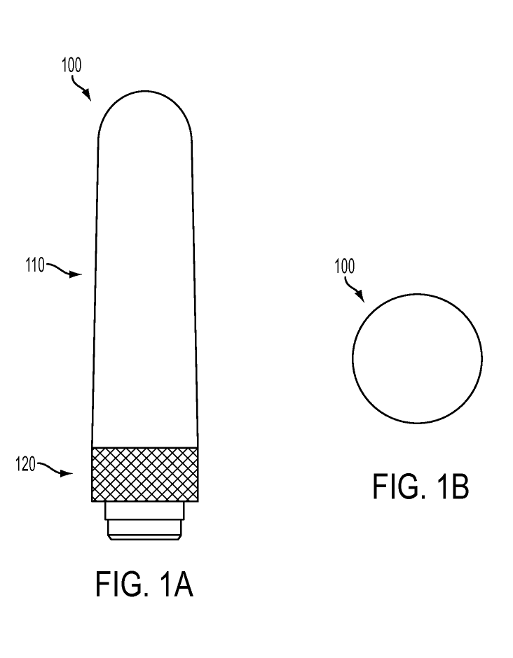

FIG. 1A is a side view of a dual band antenna 100 in accordance with disclosed embodiments, and FIG. 1B is a top view of the dual band antenna 100 in accordance with disclosed embodiments. As seen in FIG. 1A, the antenna 100 can include an upper domed body 110 and a lower connector body 120. In some embodiments, the upper domed body 110 can house various components of the antenna 100, which are discussed in further detail herein. In accordance with disclosed embodiments, the upper domed body 110 can have a predetermined size that is large enough to house the various components of the antenna 100, but that is small enough and short enough to accommodate any space and size constraints of the surrounding area, including an access point metal platform to which the antenna 100 is mounted.

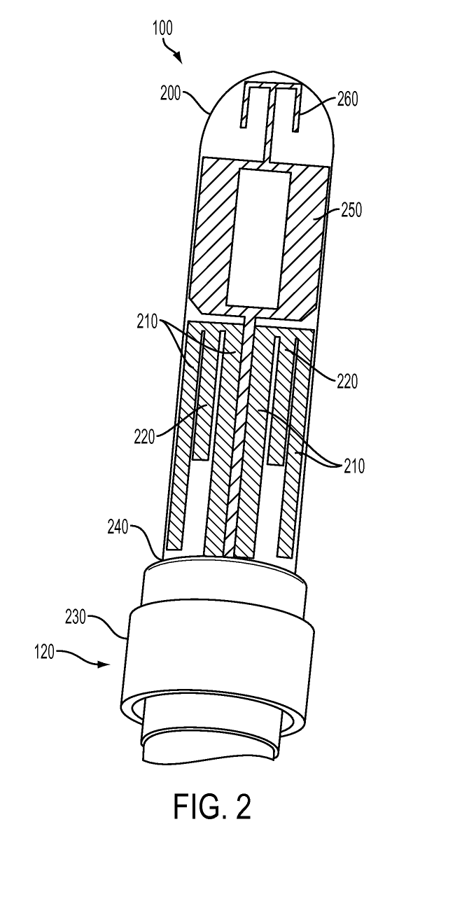

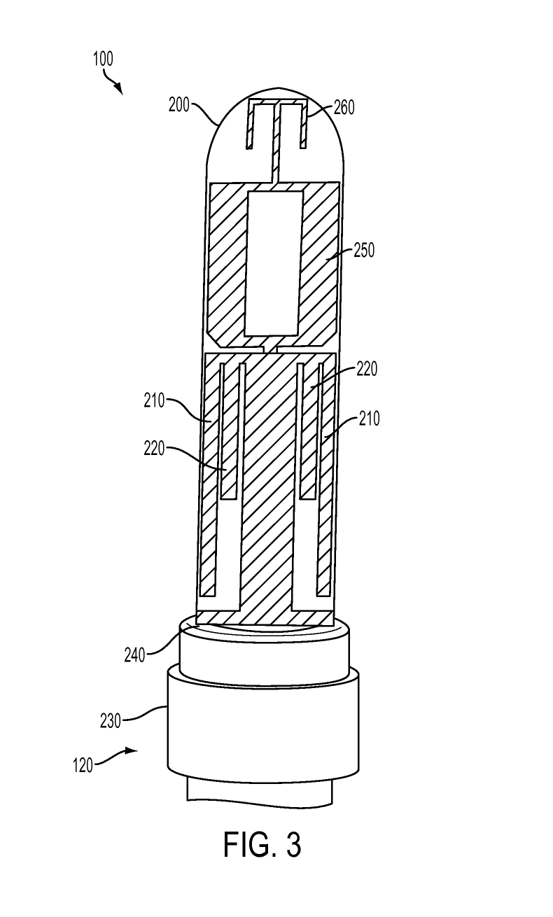

FIG. 2 is a front schematic view of a printed circuit board (PCB) 200 for a dual band antenna 100 in accordance with disclosed embodiments, and FIG. 3 is a back schematic view of the PCB 200 for the dual band antenna 100 in accordance with disclosed embodiments. The PCB 200 and the elements etched thereon can be housed within the upper domed body 110 of the antenna 100.

As seen in FIGS. 2-3, the antenna 100 can include three RF chokes 210, 220, 230. For example, first and second RF chokes 210, 220 can be etched and/or deposited onto the PCB 200 near a bottom end 240 thereof. Accordingly, the first and second RF chokes 210, 220 can be included on the PCB 200 without adding physical length to the PCB 200 or the antenna 100. In some embodiments, the first RF choke 210 can work within and/or be associated with the first, relatively lower frequency band of the antenna 100, for example, the 2.4 GHz frequency band, and in some embodiments, the second RF choke can work within and/or be associated with the second, relatively higher frequency band of the antenna 100, for example, the 5.8 GHz frequency band. Furthermore, in some embodiments, a physical length of the traces of the first RF choke 210 on the PCB 200 can be longer than a physical length of the traces of the second RF choke 220 on the PCB.

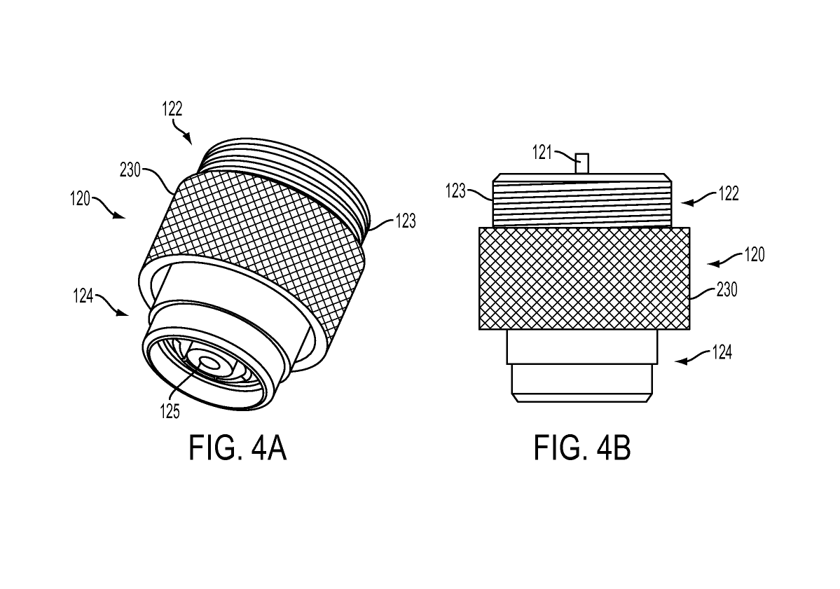

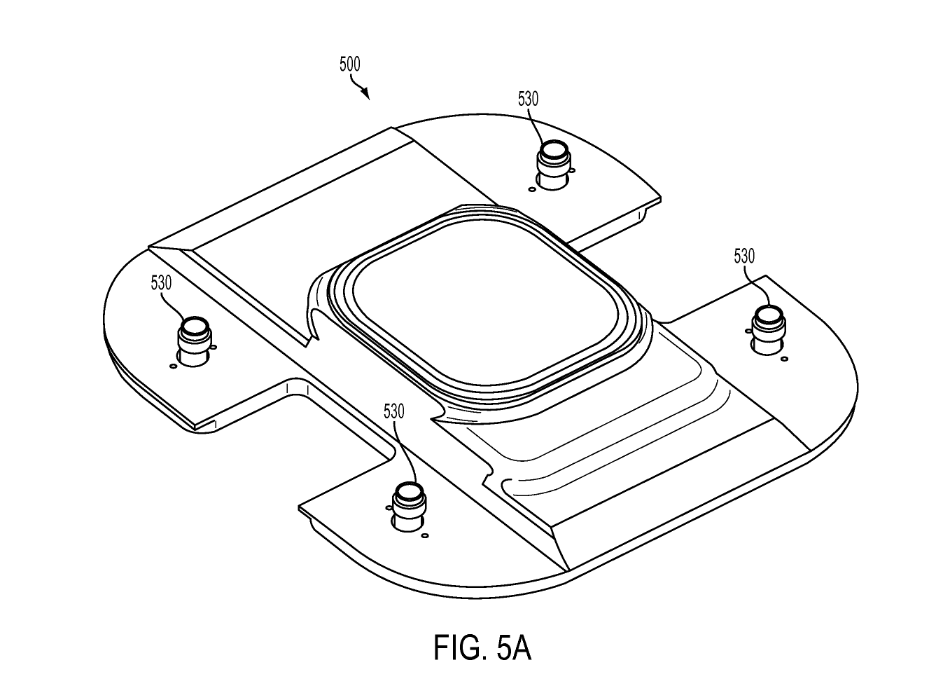

As seen in FIGS. 2-3 and in FIGS. 4A-4B, the third RF choke 230 can be embedded at or in the lower connector body 120 of the antenna 100, and in some embodiments, the third RF choke 230 can be located below the antenna elements 250, 260. In some embodiments, the third RF choke 230 can work within and/or be associated with the second, relatively higher frequency band of the antenna 100, for example, the 5.8 GHz frequency band.

The first antenna element 250 can be etched onto the PCB 200, can include a radiator and in some embodiments, can include a loop-shaped radiator. In some embodiments, the first antenna element 250 can work within and/or be associated with the second, relatively higher frequency band of the antenna, for example, the 5.8 GHz frequency band. In some embodiments, the length of the first antenna element 250 can be slightly shorter than ¼ wavelength. Furthermore, as seen in FIGS. 2-3, in some embodiments, the first antenna element 250 can have a symmetrical shape, which can provide a balanced radiation pattern.

The second antenna element 260 can also be etched onto the PCB 200, can include a radiator, and in some embodiments, can include a folded radiator that is integrated into and/or with the first antenna element 250. In some embodiments, the second antenna element 260 can work within and/or be associated with the first, relatively lower frequency band of the antenna, for example, the 2.4 GHz frequency band. In some embodiments, the second antenna element 260 can be bent into two equal parts so as to create a lower profile, and in some embodiments, the line width of the second antenna element 260 can be thin enough so as to carry high impedance characteristics and act as an open circuit to the first antenna element 250.

FIG. 4A is a perspective view of the lower connector body 120 for the antenna 100 in accordance with disclosed embodiments, and FIG. 4B is a side view of the connector body 120 for the antenna 100 in accordance with disclosed embodiments. As explained above, the RF choke 230 can be embedded at or in the connector body 120. In some embodiments, a connector pin 121 can extend from a top end 122 of the connector body 120 for connecting with the PCB 200 and the antenna elements 250, 260 etched thereon. In some embodiments, the top end 122 of the connector body 120 can also include a connecting mechanism 123, for example, a screw thread, for connecting and/or mating with the upper domed body 110. In some embodiments, a bottom end 124 of the connector body 120 can include a connecting mechanism 125 for connecting to a WiFi access point metal platform as would be understood by those of skill in the art.

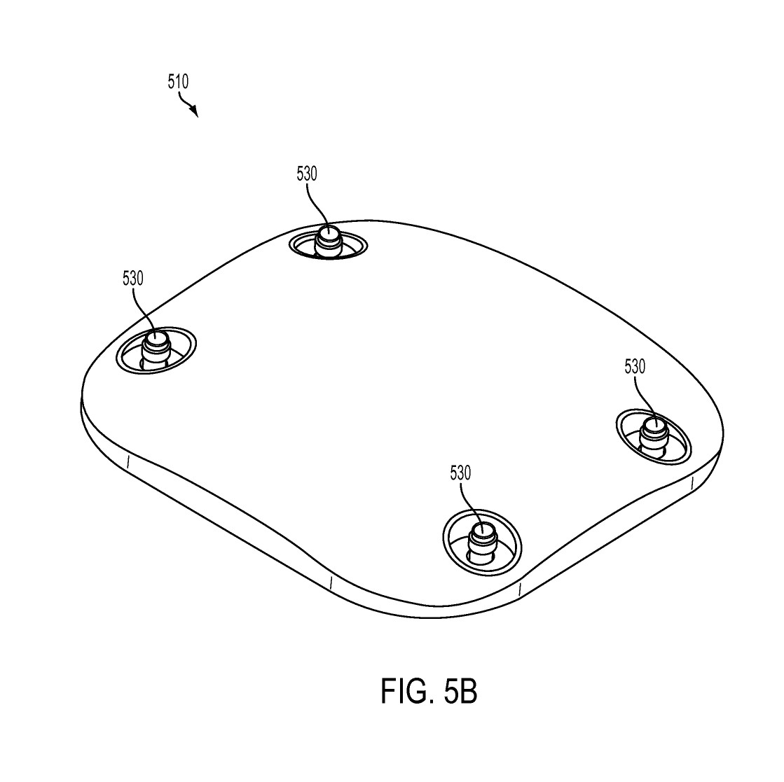

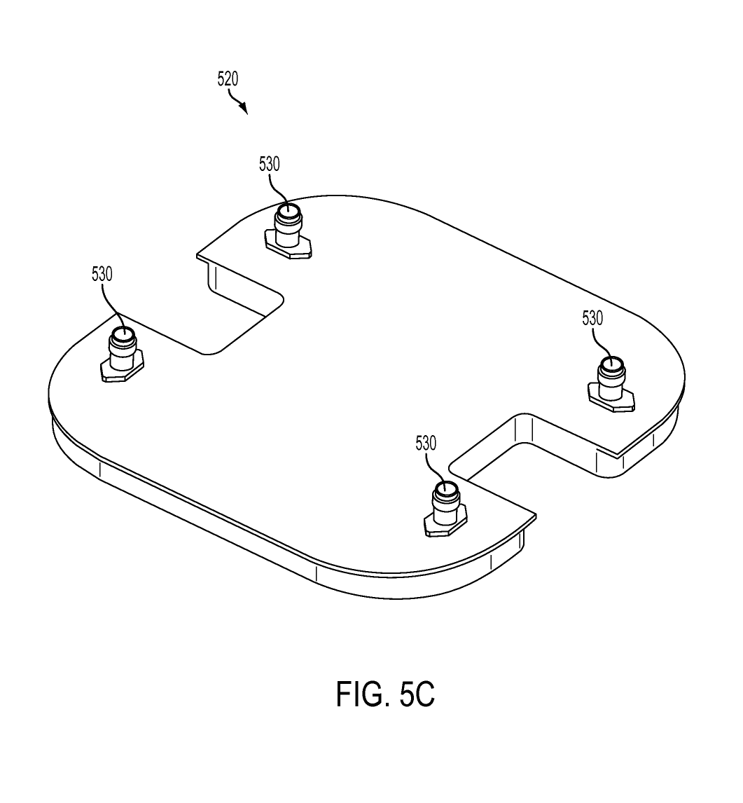

In some embodiments, the antenna 100 as disclosed herein and/or a plurality of the antennas 100 can connect to and/or be mounted onto a WiFi access point metal platform. For example, FIGS. 5A-5C are perspective views of first, second, and third WiFi access point metal platforms 500, 510, 520, respectively, onto which the antenna 100 and/or a plurality of the antennas 100 can be mounted. As seen, each of the platforms 500, 510, 520 includes a plurality of hubs 530 for mating with a respective connector body 120 of an antenna 100.

As also seen, each of the platforms 500, 510, 520 can have a different footprint, a different shape, a different dimension, a different size, and the like. That is, in some embodiments, the antenna 100 as disclosed herein can be used in connection with at least three different WiFi access point metal platforms. However, it is to be understood that the footprint, shape, dimension, and size of the platforms 500, 510, 520 shown and described herein are not limitations of the present invention. Rather, it is to be understood that the platforms 500, 510, 520 shown in FIGS. 5A-5C, respectively, are exemplary only and representative of the fact that the antenna 100 as disclosed herein can be used in connection with a plurality of different platforms having different footprints, shapes, dimensions, and sizes that can be determined, for example, by the needs and requirements of a user or customer.

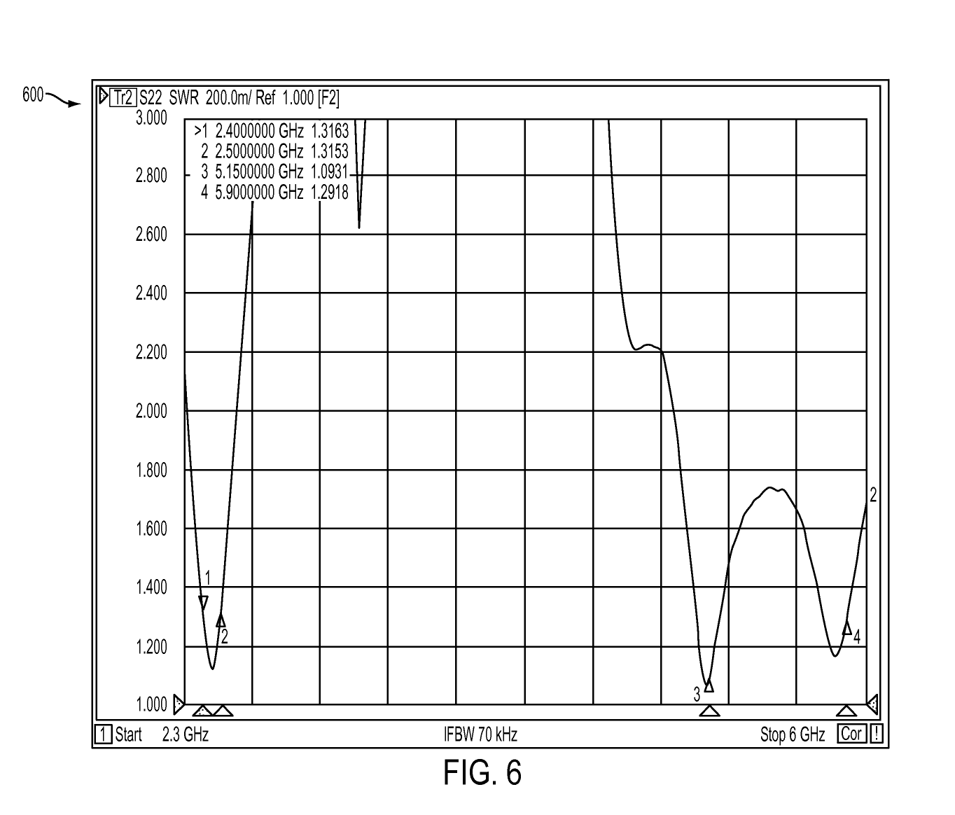

FIG. 6 is a graph 600 of exemplary test data showing a standing wave ratio (SWR) of the antenna 100 in accordance with disclosed embodiments. As seen in FIG. 6, at approximately 2.4 GHz, the SWR of the antenna 100 can be approximately 1.3163. At approximately 2.5 GHz, the SWR of the antenna 100 can be approximately 1.3153. At approximately 5.15 GHz, the SWR of the antenna 100 can be approximately 1.0931. At approximately 5.9 GHz, the SWR of the antenna 100 can be approximately 1.2918.

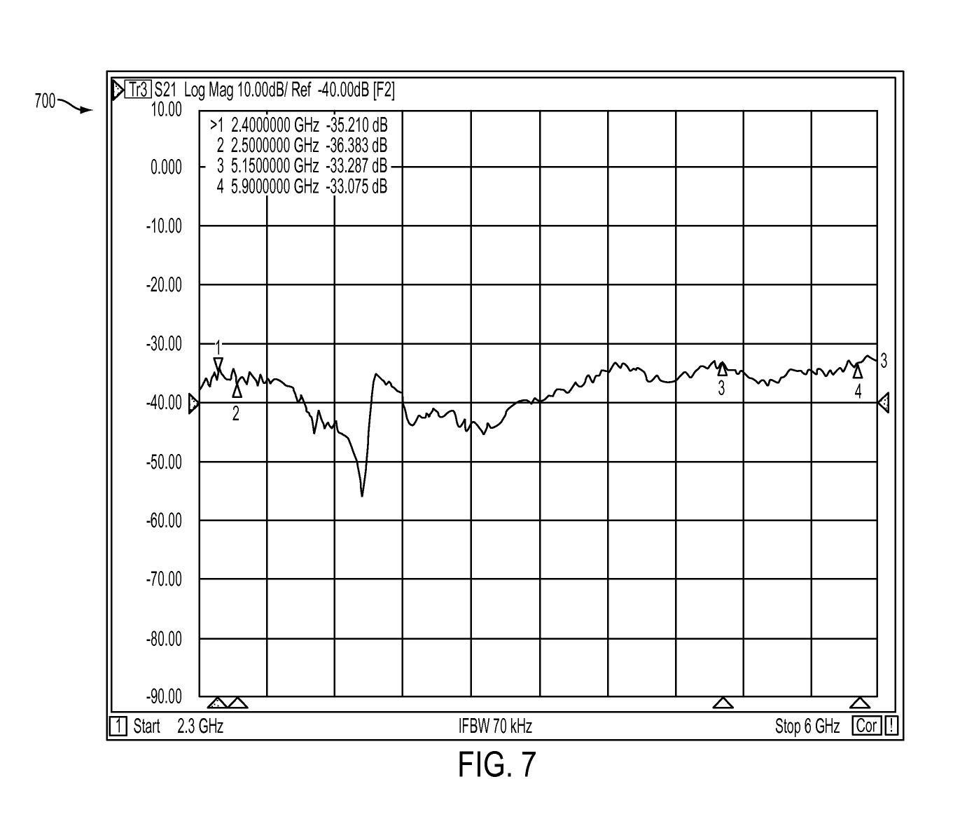

FIG. 7 is a graph 700 of exemplary test data showing isolation vs. frequency of the antenna 100 in accordance with disclosed embodiments. As seen in FIG. 7, at approximately 2.4 GHz, the antenna 100 can achieve isolation of approximately −35.210 dB. At approximately 2.5 GHz, the antenna 100 can achieve isolation of approximately −36.383 dB. At approximately 5.15 GHz, the antenna 100 can achieve isolation of approximately −33.287 dB. At approximately 5.9 GHz, the antenna 100 can achieve isolation of approximately −33.075 dB.

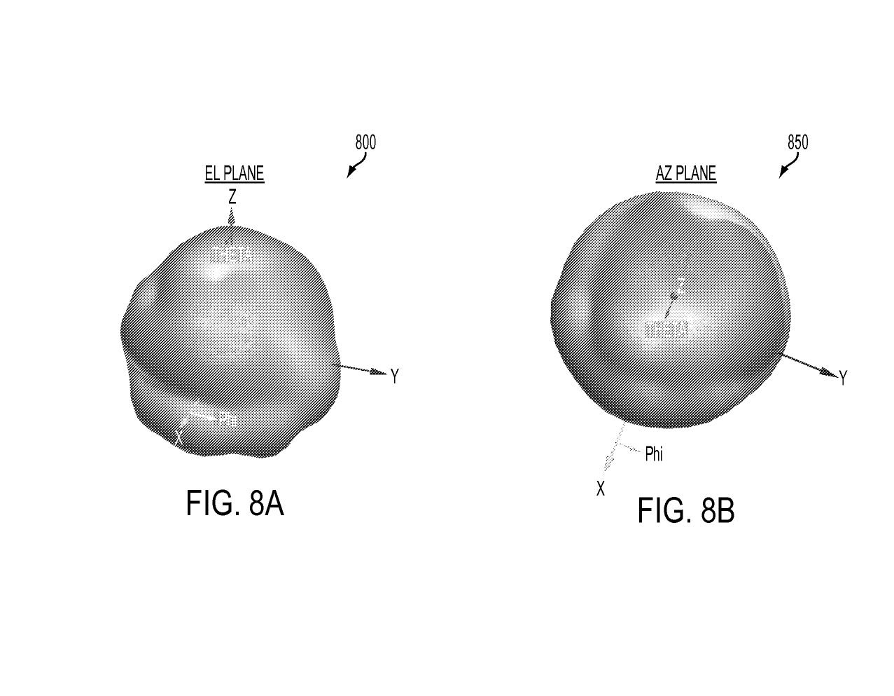

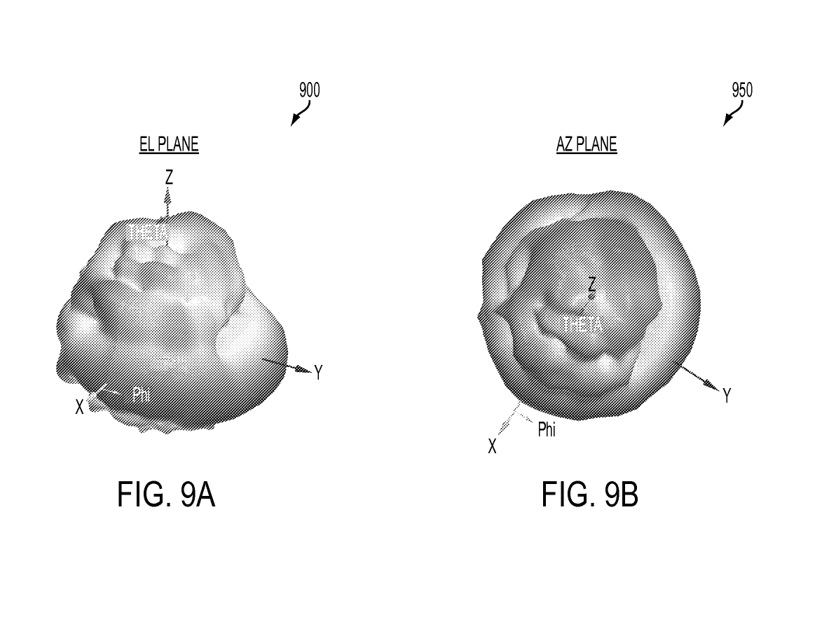

Finally, FIGS. 8A-9B are three dimensional graphs 800, 850, 900, 950, respectively of exemplary radiation patterns that can be generated by the antenna 100 as disclosed herein when mounted on a WiFi access point metal platform 500, 510, or 520 in accordance with disclosed embodiments. For example, the graph 800 in FIG. 8A illustrates the radiation pattern of the antenna 100 in the 2.4 GHz frequency band in the EL plane, FIG. 8B illustrates the radiation pattern of the antenna 100 in the 2.4 GHz frequency band in the AZ plane, FIG. 9A illustrates the radiation pattern of the antenna 100 in the 5.8 GHz frequency band in the EL plane, and FIG. 9B illustrates the radiation pattern of the antenna 100 in the 5.8 GHz frequency band in the AZ plane.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. An apparatus comprising:
a printed circuit board;
a first antenna element etched onto the printed circuit board, the first antenna element working within a first frequency band;
a second antenna element etched onto the printed circuit board, the second antenna element working with a second frequency band;
a first RF choke etched onto the printed circuit board near a first end of the printed circuit board, the first RF choke working within the first frequency band; and
a second RF choke etched onto the printed circuit board near the first end of the printed circuit board, the second RF choke working within the second frequency band.

2. The apparatus as in claim 1 further comprising an upper domed body housing the printed circuit board, the first antenna element, the second antenna element, the first RF choke, and the second RF choke.

3. The apparatus as in claim 1 wherein the first frequency band includes a relatively higher frequency band.

4. The apparatus as in claim 3 wherein the first frequency band includes a 5.8 GHz frequency band.

5. The apparatus as in claim 1 wherein the second frequency band includes a relatively lower frequency band.

6. The apparatus as in claim 5 wherein the second frequency band includes a 2.4 GHz frequency band.

7. The apparatus as in claim 1 further comprising a third RF choke embedded in a connector body below the first and second antenna elements.

8. The apparatus as in claim 1 wherein the first antenna element includes a radiator.

9. The apparatus as in claim 8 wherein the first antenna element includes a loop-shaped radiator.

10. The apparatus as in claim 9 wherein a length of the first antenna element is approximately ¼ wavelength.

11. The apparatus as in claim 9 wherein the loop-shaped radiator is symmetrical.

12. The apparatus as in claim 1 wherein the second antenna element includes a radiator.

13. The apparatus as in claim 12 wherein the second antenna element includes a folded radiator.

14. The apparatus as in claim 13 wherein a length of the second antenna element is approximately ¼ wavelength.

15. The apparatus as in claim 13 wherein the second antenna element is integrated into the first antenna element.

16. The apparatus as in claim 13 wherein the folded radiator is bent into two equal parts.

17. The apparatus as in claim 1 wherein the second antenna element acts as an open circuit to the first antenna element.

18. The apparatus as in claim 1 further comprising a connector body for mounting on a plurality of different WiFi access point metal platforms.

19. The apparatus as in claim 18 wherein the connector body includes a connector pin for connecting with the printed circuit board.

20. The apparatus as in claim 1 wherein each of the first and second RF chokes includes a high impedance section.
